(19) United States
(12) Patent Application Publication
(10) Pub. No.: US 2008/0052053 A1
(43) Pub. Date: Feb. 28, 2008

(54) INFORMATION PROCESSING APPARATUS AND METHOD THEREOF

(75) Inventor: Akira Yoshihara, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 11/845,162

(22) Filed: Aug. 27, 2007

(30) Foreign Application Priority Data
Aug. 28, 2006 (JP) 2006-230733

(51) Int. Cl. G06G 7/48

(52) U.S. Cl. 703/6

(57) ABSTRACT

An information processing apparatus that can reduce an operation time for mesh generation and also reduce erroneous determination on a contact section. A memory stores a contact determination criterion of parts corresponding to a combination of part kinds of parts as CAD data. A processing unit subjects an extracted combination of the parts to the contact determination, based on the contact determination criterion stored in the memory, and highlights the combination of the parts determined to contact to each other, on a displaying unit.

### BACKGROUND OF THE INVENTION

1. Field of the Invention

The present invention relates to an information processing apparatus and a method thereof, and more particularly, to an information processing apparatus and a method thereof that generate a mesh used for a finite element method analysis of a graphic shape drawn in three dimensional CAD.

2. Description of the Related Art

A conventional analysis model generation method recognizes a fastening section of modeling target parts from a three dimensional CAD drawing, and based on the recognition, applies an appropriate fastening model database (for example, see Japanese Laid-Open Patent Publication (Kokai) No. 2001-265836). The fastening section of the modeling target parts is extracted by searching a contact section from geometric information. In this search, contact determination is performed with respect to all parts in an all possible regression manner. The extracted parts are registered as “part fastening data”, and modeled by applying the appropriate fastening model database thereto.

However, the conventional analysis model generation method has problems as described below.

(1) Since the number of combinations of two parts which may contact to each other increases by square of the number of the parts, the contact determination with respect to all combinations of the parts is very time consuming with determination operations.

(2) If fastening is determined based on the contact, for example, fastening which has no contact such as an adhesion having clearance, a case where the parts have not been drawn in a contact state on the CAD drawing (fastening in a denting state (spring urging)) and the like cannot be determined. In order to determine them to be in the contact state, it is necessary to determine two parts within a threshold to be in the contact state. However, such determination with respect to all combinations of the parts increases an amount of the determination operations. Moreover, sections determined to contact to each other may include many sections which actually have no contact, which requires a large amount of labor for a manual post process.

### SUMMARY OF THE INVENTION

The present invention provides an information processing apparatus and a method thereof that can reduce an operation time for mesh generation and also reduce erroneous determination on a contact section.

In a first aspect of the present invention, there is provided an information processing apparatus comprising: a memory adapted to store information about a contact determination criterion of parts corresponding to a combination of part kinds of parts as CAD data; and a processing unit adapted to subject an extracted combination of the parts to the contact determination, based on the contact determination criterion stored in the memory, and highlight the combination of the parts determined to contact to each other, on a displaying unit.

The contact determination criterion can include at least one of information related to a combination of elements of the parts to be subjected to the contact determination, information related to a boundary shape of the contact section, and the clearance information.

In a second aspect of the present invention, there is provided an information processing method comprising the steps of: a determination step of subjecting an extracted combination of parts to the contact determination, based on a contact determination criterion of the parts corresponding to a combination of part kinds of parts as CAD data; and a processing step of highlighting the combination of the parts determined to contact to each other in the determination step, on a displaying unit.

The contact determination criterion can include at least one of information related to a combination of elements of the parts to be subjected to the contact determination, information related to a boundary shape of the contact section, and the clearance information.

According to the present invention, it is possible to reduce the time for searching a target graphic and also reduce the erroneous determination on the contact section.

Further features and aspects of the present invention will become apparent from the following detailed description of exemplary embodiments with reference to the attached drawings.

### BRIEF DESCRIPTION OF THE DRAWINGS

FIG. 1 is a block diagram schematically showing an internal configuration of an information processing apparatus according to an embodiment of the present invention.

FIG. 2 is a flowchart showing the procedure of an analysis model generation processing executed by the information process apparatus of FIG. 1.

FIG. 3 is a perspective view of modeling target parts applied with the analysis model generation processing program of FIG. 2.

FIG. 4 is a partially enlarged view of a substantial section of the modeling target parts of FIG. 3.

FIG. 5 is a diagram of a screen of a display of a computer which executes the program of FIG. 2, showing a case of setting part kinds to the modeling target parts of FIG. 3.

FIG. 6 is a diagram showing parts in a state where they have been subjected to contact determination, on the screen of the display of the computer which executes the analysis model generation processing program of FIG. 2.

FIG. 7 is a diagram showing a fastening section between the parts, on the screen of the display of the computer which executes the analysis model generation processing program of FIG. 2.

FIG. 8 is a diagram showing a mesh of part shapes depending on a fastening state, on the screen of the display of the computer which executes the analysis model generation processing program of FIG. 2.

### DETAILED DESCRIPTION OF THE PREFERRED EMBODIMENTS

The present invention will now be described in detail below with reference to the drawings showing preferred embodiments thereof.

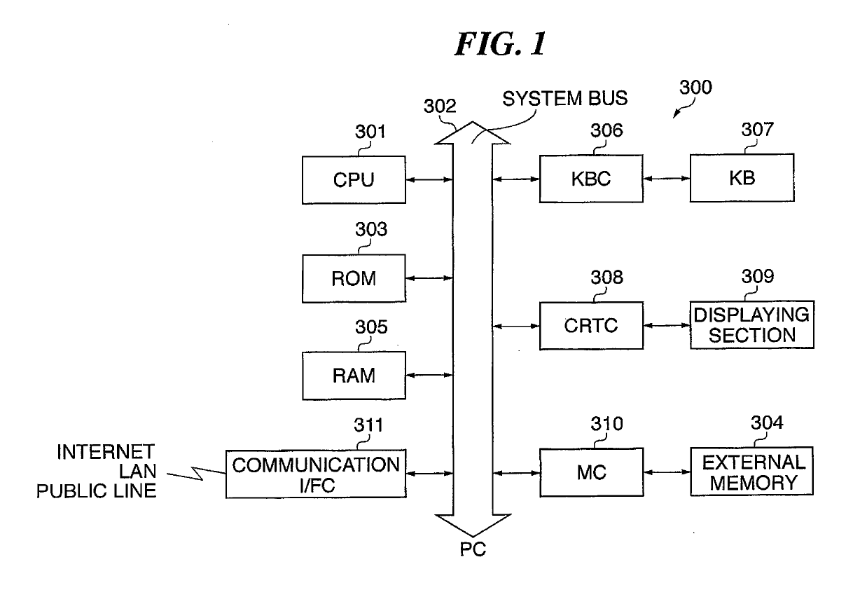

FIG. 1 is a block diagram schematically showing an internal configuration of an information processing apparatus according to an embodiment of the present invention.

In FIG. 1, a computer 300 as the information processing apparatus is provided with a CPU 301, a system bus 302, a ROM 303, an external memory 304, a RAM 305 and a keyboard controller (KBC) 306. The computer 300 is further provided with a keyboard (KB) 307, a CRT controller (CRTC) 308, a displaying unit 309, an external memory controller (MC) 310 and a communication I/F controller (I/FC) 311.

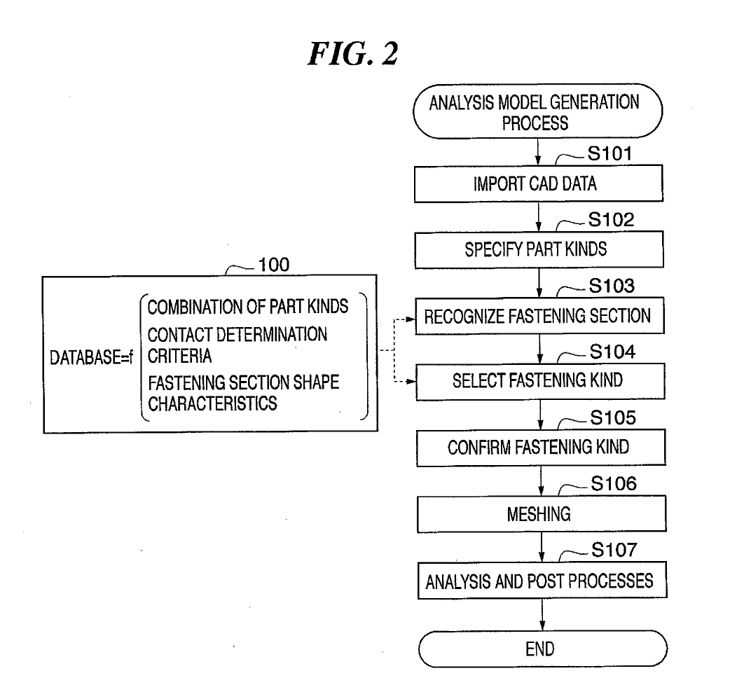

The CPU 301 has an overall control of the respective devices connected to the system bus 302. The ROM 303 stores an operating system (OS) which is a control program for the CPU 301, an analysis model generation processing program of FIG. 2 as described below, and the like. The ROM 303 further stores programs required for realizing operations (such as application programs, various drivers such as a FAX driver, and the like). The RAM 305 functions as a maim memory, a work area or the like for the CPU 301, and the keyboard controller (KBC) 306 controls inputs from the keyboard 307 or a pointing device (not shown). The CRT controller (CRTC) 308 controls display to the displaying unit (a liquid crystal, a CRT or the like) 309. The external memory controller (MC) 310 controls accesses to the external memory 304. The external memory 304 consists of a hard disk (HD), a floppy® disk (FD), a compact flash® memory® and the like. The hard disk (HD) stores various applications such as a boot program, a sales management program which is general purpose software, or a program for performing a recognition process including an OCR process with respect to image data, or data correction and the like, as well as user files, editing files and the like. Moreover, the compact flash® memory is connected via an adapter to a PCMCIA card slot. The communication I/F controller (I/FC) 311 is communicably connected to external devices via a LAN with TCP/IP, or via a USB which is a local general purpose interface or a network of 1394 or the like, and executes various communication control processes.

The various programs stored in the ROM 303 may be stored in an external memory (HD) (not shown).

Moreover, the CPU 301 enables the display to the displaying unit 309, for example, by executing a process of expanding (rasterizing) display information to an information display area of the RAM 305. Moreover, if a program stored in the ROM 303 is executed, the CPU 301 loads the program to the RAM 305 once and causes the RAM 305 to execute it, and thereby realize various functions and operations as described below.

FIG. 2 is a flowchart showing the procedure of an analysis model generation process executed by the information processing apparatus of FIG. 1.

An analysis model generation method is achieved by reading and executing the analysis model generation processing program for executing processes of FIG. 2 by the computer 300 of FIG. 1 which is the information processing apparatus (or by the CPU, an MPU or the like). This computer 300 has a database 100 (FIG. 2) represented by functions of part kinds, contact determination criteria and fastening section shape characteristics, as a database for the analysis model generation processing program. The database 100 is stored in a nonvolatile storage medium such as the hard disk.

Hereinafter, the analysis model generation processing program of FIG. 2 will be described in detail with an example of a unit having multiple parts fastened.

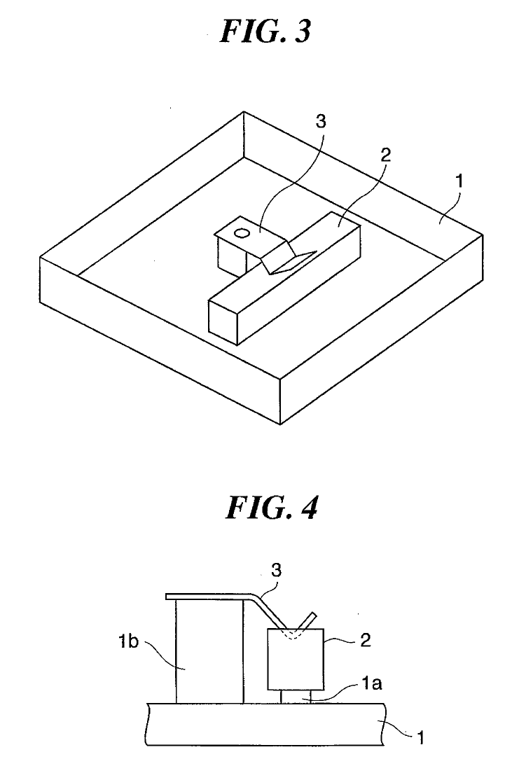

FIG. 3 is a perspective view of modeling target parts applied with the analysis model generation process of FIG. 2, and FIG. 4 is a partially enlarged view of a substantial section of the modeling target parts of FIG. 3.

In FIG. 4, these modeling target parts are configured with a box model 1, a lens model 2 as an optical part attached to a convex section 1a on a bottom section of the box model 1, and a spring model 3 attached to a convex section 1b on the bottom section of the box model 1 and also holding down the lens model 2.

The database 100 for the analysis model generation processing program of FIG. 2 is a fastening database which defines a method of modeling a fastening shape of the modeling target parts. Specifically, the database 100 has a database related to combinations of part kinds to be subjected to contact determination, and fastening methods (Table 1). Moreover, the database is configured so that it constructs information for subjecting the parts to the contact determination with respect to the fastening method (a contact determination element, a contact boundary shape, a contact determination criterion, and a mesh division condition) (Table 2).

TABLE 1

| | | | Fastening |
|---|---|---|---|
| Database No. | Target part A | Target part B | method |
| 1 | Box | Lens | Type 01 |
| 2 | Box | Spring | Type 02 |
| 3 | Spring | Lens | Type 03 |

TABLE 2

| | | | | Mesh division condition | | | | |
|---|---|---|---|---|---|---|---|---|
| | | Contact | Contact | Radial pattern | | Lattice pattern | | |
| | Contact | section | determination | Angular | Radius | Longitudinal | Transverse | |
| Fastening | determination | boundary | criterion | division | division | division | division | Fastening |
| method | element | shape | (clearance) | number | number | number | number | condition |
| Type 01 | Surface/ | Rectangle | 0.01 mm | — | — | 2 | 2 | Binding in |
| | Surface | | | | | | | vertical |
| | | | | | | | | direction to |
| | | | | | | | | surface |
| Type 02 | Surface/ | Circular | 0.01 mm | 6 | 2 | — | — | Binding in |
| | Surface | arc | | | | | | all |
| | | | | | | | | transmitted |
| | | | | | | | | direction |
| Type 03 | Surface/ | Half line | 1 mm | — | — | 6 | — | Binding in |
| | Ridge line | | | | | | | vertical |
| | | | | | | | | direction to |
| | | | | | | | | surface |
| | | | | | | | | Binding in |
| | | | | | | | | ridge line |
| | | | | | | | | direction |

Table 1 shows a condition for determining the contact of the parts (a type of the fastening method) for each combination of kinds of the modeling target parts when a model is generated as a fastening section of the modeling target parts. Table 2 shows, for example, the contact determination element, the boundary shape, the contact determination criterion (clearance) and the mesh division condition (radial pattern, lattice pattern), as a model generation condition (a contact determination condition) for each of fastening method type 01, type 02 and type 03 of Table 1.

The combinations of the parts listed in Table 1 are the combinations of the respective part kinds of these modeling target parts. Each fastening method is configured to refer to Table 2.

In FIG. 2, first, when a user's instruction is detected, the CPU imports CAD data of a design drawing as the modeling target parts to the RAM of the information processing apparatus from an external CAD device (step S101). Then, a specification of the part kinds by the user is detected as an attribute for graphic data of the imported modeling target parts (step S102).

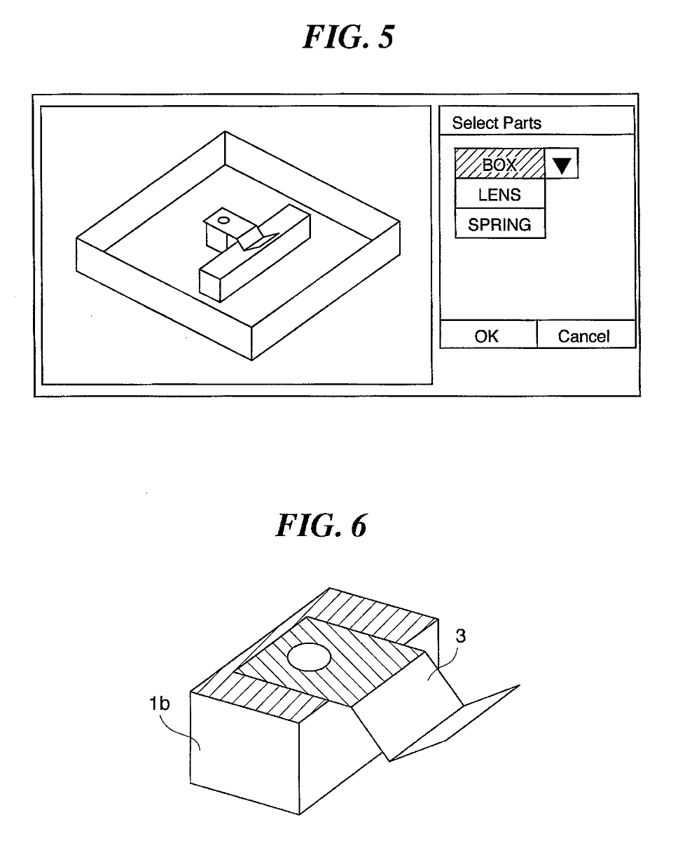

FIG. 5 is a diagram of a screen of a display of the computer which executes the analysis model generation processing program of FIG. 2, showing a case of setting the part kinds to the modeling target parts of FIG. 3.

It is detected that a part to which the part kind is set has been selected from the modeling target parts displayed on the screen. Then, the selected part is highlighted. If the part kind is set to “Box”, the part kind of “Box” is set to the box model 1 by selecting “Box” in a “Select Parts” dialog. Similarly, the part kinds are specified to all of the modeling target parts.

Next, based on the fastening database in the database 100, the CPU detects settings of fastening section recognition and fastening kind selection (steps S103 and S104). Then, the CPU registers the combination of the part kinds (Table 1) as well as the respective characteristics of the contact determination criterion and the fastening section boundary shape in the database 100 (step S105).

Furthermore, the CPU sets the above described contact determination criterion, and then extracts the combination of the part kinds registered in the fastening database from the graphic data of the modeling target parts, and then applies meshing (an element division process) with respect to the modeling target parts (step S106). Subsequently, the CPU performs analysis and post processes (step S107), followed by terminating the procedure.

The analysis and post processes at step S107 are performed as described below.

In other words, the CPU determines whether or not the extracted combination of the part kinds satisfies both of the respective characteristics of the contact determination criterion and the fastening section shape set with respect to the above described combination of the part kinds (the contact determination). Then, when the extracted combination of the part kinds satisfies both of the characteristics of the contact determination criterion and the fastening section shape set with respect to the above described combination of the part kinds, the above described combination of the parts is displayed. Then, a fastening model is created by applying a modeling method defined in the fastening database to the fastening section shape (FIGS. 6 to 8).

FIG. 6 shows a screen which has been subjected to the contact determination. Here, a contact section between the convex section 1b on the bottom section of the box model 1 and the spring model 3 is enlarged and displayed. The database used here is “Database No. 2” in Table 1. Surfaces determined to contact are highlighted.

It should be noted that this embodiment will be described assuming that a neutral surface has been already extracted by a known method on the premise that the spring model 3 is modeled with a shell mesh.

In this embodiment, the contact determination criterion (clearance) of the spring and the optical part of type 03 has been taken largely compared to type 01 and type 02. As shown in FIG. 4, this accommodates a case where the spring model 3 has been drawn in a natural state and drawn in a state of denting into the lens model 2, on the design drawing. Although it is not unusual that the design drawing is drawn in such a state, if the contact determination is limited only to a state of being extremely near a clearance of 0, this state cannot be determined to be a contact state.

However, if the contact has been made simply with a large clearance, many adjacent parts are erroneously determined to contact, and a selection operation by an operator takes many man-hours.

In this embodiment, since part varieties are set to the parts and the parts which become candidates to be subjected to the contact determination are refined, the erroneous determination as described above can be reduced to a minimum.

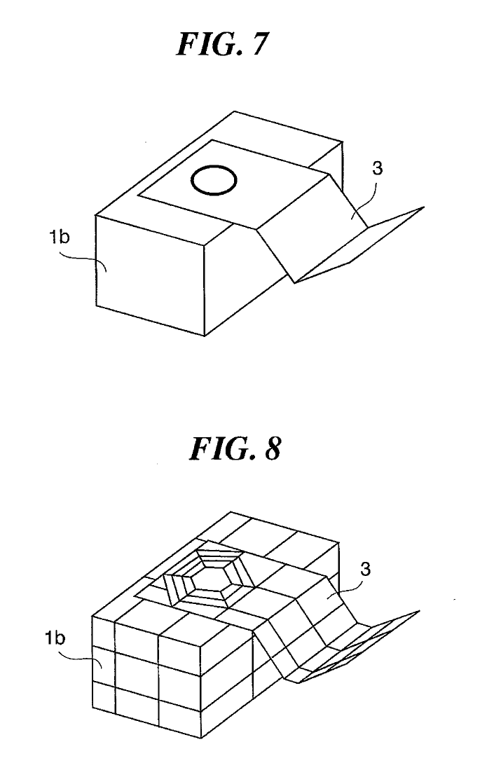

Next, if the operator determines that the surfaces determined to contact are really the contact section, and instructs to transit to the next screen, the analysis model generation program recognizes the boundary shape on the contact surfaces according to Table 2, and highlights the boundary (FIG. 7).

If the operator determines that the boundary shape is correct and instructs to generate the mesh, the analysis model generation program attaches mesh information to the contact surfaces according to Table 2. With respect to a specific method thereof, since a method of setting a point which becomes an anchor at a desired position and the like have been widely performed, detailed description thereof is omitted here.

Hereinabove, the example of modeling the fastening section between the box model 1 and the spring model 3 has been described. Similarly, the contact is recognized, the boundary is recognized, and the mesh information is attached to the contact surfaces, also between the box model 1 and the lens model 2, as well as between the spring model 3 and the lens model 2.

On the highlighted surface shown in FIG. 6, “Database No. 2” in Table 1 is recognized, the boundary highlighted in FIG. 7 is recognized, and “Type 02” in Table 2 is applied.

If the mesh is generated with respect to an analysis target model in this state, a mesh of part shapes depending on a fastening form is generated and also a binding condition is set between the parts. FIG. 8 shows an example of generating the mesh according to “Type 02” in Table 2, at a section shown in FIG. 7.

In this embodiment, the operator may select whether or not to create the fastening model by applying the modeling method defined in the fastening database to the displayed fastening section shape, and the fastening model may be created when the operator has selected to create it as described above.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of any of the embodiments described above, and hence the program code and the storage medium in which the program code is stored constitute the present invention.

Examples of the storage medium for supplying the program code include a floppy® disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program code may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2006-230733 filed Aug. 28, 2006, which is hereby incorporated by reference herein in its entirety.

What is claimed is:

1. An information processing apparatus comprising:
a memory adapted to store information about a contact determination criterion of parts corresponding to a combination of part kinds of parts as CAD data; and
a processing unit adapted to subject an extracted combination of the parts to the contact determination, based on the contact determination criterion stored in said memory, and highlight the combination of the parts determined to contact to each other, on a displaying unit.

2. An information processing apparatus according to claim 1, wherein said contact determination criterion includes at least one of information related to a combination of elements of the parts to be subjected to the contact determination, information related to a boundary shape of the contact section, and the clearance information.

3. An information processing method comprising the steps of:
a determination step of subjecting an extracted combination of parts to the contact determination, based on a contact determination criterion of the parts corresponding to a combination of part kinds of parts as CAD data; and
a processing step of highlighting the combination of the parts determined to contact to each other in said determination step, on a displaying unit.

4. An information processing method according to claim 3, wherein said contact determination criterion includes at least one of information related to a combination of elements of the parts to be subjected to the contact determination, information related to a boundary shape of the contact section, and the clearance information.
